(19) United States
(12) Patent Application Publication
(10) Pub. No.: US 2018/0201779 A1
(43) Pub. Date: Jul. 19, 2018

(54) DEGRADABLE RESIN PELLET AND MOLDED PRODUCT USING SAME

(71) Applicant: Seung Geun OH, Daejeon (KR)

(72) Inventor: Seung Geun OH, Daejeon (KR)

(21) Appl. No.: 15/741,825

(22) PCT Filed: Oct. 29, 2015
(86) PCT No.: PCT/KR2015/011481

§ 371 Date: Jan. 4, 2018

(30) Foreign Application Priority Data
Jul. 23, 2015 (KR) 10-2015-0104246

(51) Int. Cl. C08L 67/04; C08L 23/06; C08L 1/02; C08L 29/04; C08K 13/02

(52) U.S. Cl. CPC C08L 67/04; C08L 23/06; C08K 2003/265; C08L 29/04; C08K 13/02; C08L 1/02

(57) ABSTRACT

The present invention relates generally to a degradable resin pellet and a molded article produced using the same. More specifically, the present invention provides a degradable resin pellet comprising a composition comprising 100 parts by weight of polylactic acid (PLA), 50 to 150 parts by weight of calcium carbonate (CaCO₃), 0.1 to 10 parts by weight of magnesium, 0.1 to 10 parts by weight of aluminum, 0.1 to 10 parts by weight of silicon, and 0.5 to 20 parts by weight of calcium; wherein the composition is mixed with, based on 100 parts by weight of the polylactic acid (PLA), 50 to 150 parts by weight of polyvinyl alcohol (PVA), and wherein the composition is further mixed with, based on 100 parts by weight of the polylactic acid (PLA), 50 to 150 parts by weight of polyethylene (PE).

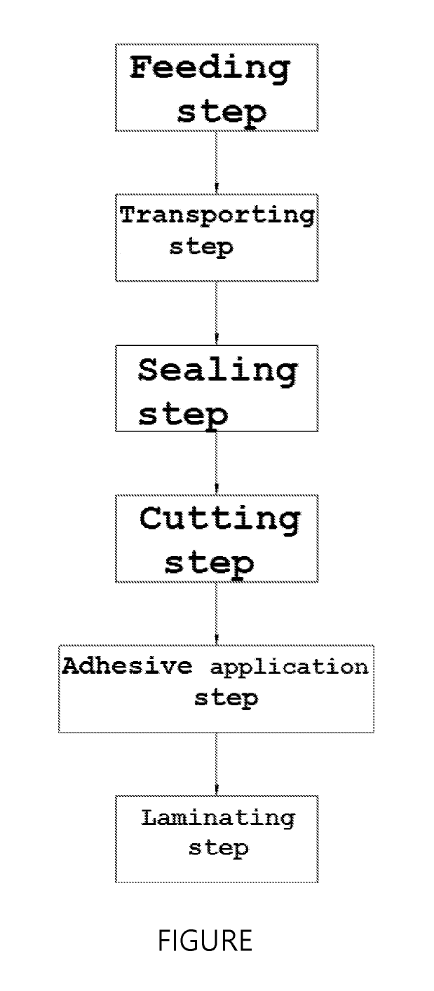

### TECHNICAL FIELD

The present invention relates generally to a degradable resin pellet and a molded article produced using the same, and more specifically to a degradable resin pellet which is obtained by mixing corn starch as a main component with polyethylene, polyvinyl alcohol and the like, which has excellent tensile strength and elongation, and which is easily biodegradable by microorganisms, photocatalytically degradable by a photocatalyst, and chemically degradable by a reaction, and to a molded article produced using the same.

### BACKGROUND ART

Generally, synthetic resins, which are petrochemical products, are widely used in various fields due to their excellent physical properties, such as chemical resistance, transparency, flexibility and rigidity, but have a problem in that they are not self-degradable after use. As environmental pollution caused by waste plastics has become a big problem in society, research on degradable resins has been actively conducted, and has attracted much attention worldwide.

In particular, as the use of landfills has been limited and the recycling of plastic waste, research and development in various fields has been conducted in order to reduce the problem of disposal of waste plastic, and development of degradable resins, which are self-degraded, have been actively made in teams of environmental preservation.

Degradable resins are roughly classified into biodegradable resins which are degraded by soil microorganisms, and photodegradable resins which are degraded by solar UV radiation. The photodegradable resins have a disadvantage in that they are not degraded after landfilling because they cannot receive light. For this reason, biodegradable resins have been mainly used.

Known biodegradable resins include resins polyhydroxyarylate-based resins synthesized by microorganisms in vivo, biodegradable polycaprolactones based on synthetic polymers, and resins obtained by filling biodegradable natural polymer resins in general purpose resins, such as polyethylene, polystyrene, polypropylene, polyethylene terephthalate, and the like.

In particular, biodegradable materials including natural polymers, such as starch, have a great advantage over synthetic resin-based biodegradable materials in that they are very inexpensive. Due to this advantage, these natural biodegradable materials including natural polymers have been considered suitable for disposable products, and thus have been widely developed and used. However, such resins including natural polymers have a disadvantage in that they do not satisfy required physical properties.

Furthermore, polyhydroxyarylate-based resins, polycaprolactones and the like have excellent degradability, but have a problem in that they are not cost-effective due to their high production costs.

As disclosed in EP 032,802, U.S. Pat. No. 4,900,361, EP 326,517, EP 032,802, EP 327,505, WO 90/10671, etc., degradable resins including starch as a natural polymer are prepared in the form of thermoplastic mixtures by adding water or a plasticizer to starch and thermoplastic resin and applying heat and pressure thereto to destroy the starch structure. However, these degradable resins cannot exhibit satisfactory effects.

In addition, degradable resins including starch as a natural polymer are disclosed in U.S. Pat. Nos. 4,755,397, 4,812,445, 4,838,944, 4,863,655, etc. According to the disclosure of these patent documents, these degradable resins include, as modified starch, esterified starch, etherified starch, oxidized starch, acid hydrolyzed starch, crosslinked starch or the like. However, these resins still do not exhibit satisfactory effects when used for biodegradable products.

### PATENT DOCUMENTS

Patent Document 1: Japanese Unexamined Patent Application Publication No. Hei 11-80522
Patent Document 2: Japanese Unexamined Patent Application Publication No. 2001-525473
Patent Document 3: Japanese Unexamined Patent Application Publication No. Hei 6-184417
Patent Document 4: Japanese Unexamined Patent Application Publication No. 2002-114893
Patent Document 5: Japanese Unexamined Patent Application Publication No. 2003-313436
Patent Document 6: Japanese Unexamined Patent Application Publication No. 2004-155993
Patent Document 7: Japanese Unexamined Patent Application Publication No. 2005-82642

### DISCLOSURE

### Technical Problem

An object of the present invention is to provide a resin pellet which overcomes the above-described problems of biodegradable resins, which can be formed into a regulation garbage bag, a plastic bag or the like, and which is degradable in nature, and a molded article produced using the same.

Another object of the present invention is to provide a biodegradable resin pellet which has flexibility and excellent tensile strength and elongation, which can be formed into a regulation garbage bag or a thin plastic bag due to its excellent processability, which is degradable by various reactions between the components thereof after use, and which is completely biodegradable by natural solid microorganisms after use so as not to cause environmental pollution, and a molded article produced using the same.

### Technical Solution

In order to accomplish the above objects and demand, the present invention provides a degradable resin pellet including polylactic acid (PLA), calcium carbonate (CaCO₃), magnesium, aluminum, silicon and calcium.

The present invention also provides a degradable resin pellet, further including polyvinyl alcohol (PVA) and/or polyethylene (PE).

The present invention also provides a degradable resin pellet including a composition including 100 parts by weight of polylactic acid (PLA), 50 to 150 parts by weight of calcium carbonate (CaCO₃), 0.1 to 10 parts by weight of magnesium, 0.1 to 10 parts by weight of aluminum, 0.1 to 10 parts by weight of silicon, and 0.5 to 20 parts by weight of calcium;

wherein the composition is mixed with, based on 100 parts by weight of the polylactic acid (PLA), 50 to 150 parts by weight of polyvinyl alcohol (PVA);

wherein the composition is further mixed with, based on 100 parts by weight of the polylactic acid (PLA), 50 to 150 parts by weight of polyethylene (PE); and

wherein the composition is further mixed with, based on 100 parts by weight of the polylactic acid (PLA), 5 to 10 parts by weight of a thermal stabilizer, 5 to 15 parts by weight of 2,5-dimethyl-1-2,5-di(tert-butylperoxide)hexane (C₁₆H₃₄O₄), 5 to 15 parts by weight of plant sugar (C₁₂H₂₂O₁₁), and 5 to 25 parts by weight of isopropyl titanium triisostearate (C₅₇H₁₁₂O₇Ti).

The present invention also provides a degradable resin pellet, wherein the composition is further mixed with, based on 100 parts by weight of the polylactic acid (PLA), 0.1 to 1 part by weight of ethyl acetate, and 0.2 to 2 parts by weight of methyl methacrylate.

The present invention also provides a degradable, wherein the composition is further mixed with, based on 100 parts by weight of the polylactic acid (PLA), 0.2 to 1 part by weight of one or more compounds selected from the group consisting of polyalkylene oxide, aliphatic polyester, polyhydric alcohol ester, and polyhydric carboxylic acid ester.

The present invention also provides a degradable resin pellet,

further including, based on 100 parts by weight of the polylactic acid (PLA), 10 to 60 parts by weight of dry starch and 0.3 to 4 parts by weight of a polyolefin grafted with carboxylic acid or an anhydride thereof, and

further including, based on 100 parts by weight of the polylactic acid (PLA), 0.5 to 5 parts by weight of cellulose, 0.3 to 3 parts by weight of amide, and 0.5 to 5 parts by weight of blue-green algae or yeast.

The present invention also provides a molded article produced using the degradable resin pellet.

### Advantageous Effects

The degradable resin and molded article according to the present invention overcomes the problems of conventional degradable resins, can be formed into a regulation garbage bag, a plastic bag or the like, and are biodegradable in nature.

In addition, the degradable resin and molded article according to the present invention has flexibility and excellent tensile strength and elongation, can be famed into a regulation garbage bag or a thin plastic bag due to its excellent processability, is degradable by various reactions between the components thereof after use, and is completely biodegradable by natural solid microorganisms after use so as not to cause environmental pollution.

### DESCRIPTION OF DRAWINGS

FIGURE is a diagram showing a conventional process of producing a molded article (bag) using a degradable resin pellet.

### MODE FOR INVENTION

The present invention will be described in detail below.

The present invention provides a degradable resin pellet including polylactic acid (PLA), calcium carbonate (CaCO₃), magnesium, aluminum, silicon and calcium.

The present invention also provides a molded article produced using the degradable resin pellet including polylactic acid (PLA), calcium carbonate (CaCO₃), magnesium, aluminum, silicon and calcium.

As used herein, the team “molded article” refers to an article, such as a regulation garbage bag or a thin plastic bag.

In a preferred embodiment, the present invention provides a degradable resin pellet including 100 parts by weight of polylactic acid (PLA), 50-150 parts by weight of calcium carbonate (CaCO₃), 0.1-10 parts by weight of magnesium, 0.1 to 10 parts by weight of aluminum, 0.1 to 10 parts by weight of silicon, and 0.5 to 20 parts by weight of calcium.

As used herein, the term “polylactic acid (PLA) refers to an environmentally friendly resin extracted from corn starch.

PLA is safe even if hot food is put therein or even if it is bitten or sucked by the baby because not only environmental hormones, but also toxic substances, such as heavy metals, are not detected in PLA. PLA shows properties equal to those of general plastics during use, but is completely biodegraded by microorganisms when disposed as waste.

The calcium carbonate (CaCO₃), magnesium, aluminum, silicon and calcium, which are used in the present invention, serve to prevent a molded article, produced using the degradable resin pellet, from being damaged by external force, thereby significantly enhancing the durability of the molded article.

The calcium carbonate (CaCO₃) has the chemical formula CaCO₃ and is the most abundant salt in nature. It is present in various forms in marble, calcite, aragonite, limestone, chalk, Iceland spar, shell, egg shell, coral, etc. It is generally present as a colorless crystal or a white solid, has a specific gravity of 2.93, and decomposes at 825° C. Heating of calcium carbonate generates carbon dioxide and quicklime. The following reaction is an important reaction for industrially producing carbon dioxide and quicklime:

CaCO₃→CaO+CO₂↑

Calcium carbonate does not dissolve in pure water, but dissolves in water containing carbon dioxide to produce calcium hydrogen carbonate:

CaCO₃+CO₂+H₂O↔Ca(HCO₃)₂

In addition, when an acid acts on calcium carbonate, carbon dioxide is generated:

CaCO₃+2HCl→CaCl₂+H₂O+CO₂↑

When carbon dioxide-containing water meets limestone in the earth, it dissolves to make a cavity, which is a limestone cave. The dissolved water is decomposed by geothermal heat or the like and precipitates calcium carbonate. When this precipitation occurs in a limestone cave, stalactites or stalagmites is produced.

In order to obtain calcium carbonate in the laboratory, alkali carbonate is added to a water-soluble calcium salt, or carbon dioxide is passed through the lime water. Industrially, calcium carbonate is obtained by pulverizing limestone and sieving the powder or subjecting the powder to free falling operation (separating particles according to size or specific gravity using the difference in velocity when solid particles freely fall in air). This type of calcium carbonate is known as heavy calcium carbonate. Alternatively, precipitates formed by blowing carbon dioxide into lime milk are filtered, dried and finely pulverized. Calcium carbonate obtained by this method is known as light calcium carbonate. In addition, calcium carbonate can also be obtained by wet crushing of shell. Calcium carbonate is widely used in industrial fields because it is cheap and has a low specific gravity. Specifically, calcium carbonate is used as limestone or marble, a raw material for cement, and a neutralizing agent for steel and construction materials. In addition, calcium carbonate obtained from shell is used in pigments and aqueous paints, and precipitated calcium carbonate is used in pigments, paints, toothpastes or the like and is also used as a reinforcement for rubber.

Magnesium (Mg) that is used as an additive in the present invention may be conventional magnesium powder.

In dry air, magnesium is not oxidized at room temperature because it has a thin oxide layer formed on the surface thereof. However, in humid air, magnesium quickly loses its gloss and becomes a faint color. When a thin magnesium film or magnesium powder is heated strongly in air, it generates brilliant light and burns to form magnesium oxide, and some of it becomes magnesium nitride. Magnesium reacts directly with nitrogen at high temperatures. Magnesium vapor shows a band spectrum by MgH in low-pressure hydrogen, but there is no convincing evidence that hydride is liberated. Magnesium reacts violently with fluorine at room temperature and ignites in humid chlorine. It combines with bromine or iodine at high temperature to produce magnesium halide. It also combines with sulfur, selenium, phosphorus, arsenic or antimony at high temperatures and also combines directly with carbon, silicon, boron, and so on. In red heat, magnesium reduces carbon monoxide, carbon dioxide, nitrogen oxide, dinitrogen monoxide or sulfur dioxide, and also reduce most metal oxides to liberate metals. In addition, magnesium is hardly affected by cold water, because the surface thereof is protected by an oxide layer.

Magnesium amalgam reacts severely with cold water, and magnesium powder generates hydrogen in hot water and produces magnesium hydroxide. Magnesium reacts with hydrogen peroxide to produce hydroxide. Magnesium dissolves in dilute acid while generating hydrogen. It reacts with concentrated sulfuric acid to generate sulfur dioxide or hydrogen sulfide, and reacts with concentrated nitric acid to generate nitric oxide, a small amount of nitrogen, dinitrogen monoxide and hydrogen, and also produce ammonium nitrate. It dissolves in dilute nitric acid while generating hydrogen and nitrogen oxide. It does not dissolve in aqueous alkali solution but dissolves when ammonia coexists. It dissolves in liquid ammonia. It forms amalgam with mercury and also forms alloys with many other metals. It reacts with methanol at 200° C. to produce magnesium methoxide. It reacts with many organic iodine compounds in ether solution to produce alkyl magnesium iodides (Grignard reaction).

Aluminum (Al) that is used as an additive in the present invention may be conventional aluminum powder or aluminum oxide.

Aluminum, together with oxygen and silicon, is one of the major constituents of Earth's crust. Aluminum is widely present in large quantities on the earth, and the Clarke number thereof is third after oxygen and silicon and is the first among the metal elements. It exists as aluminosilicates of various metals and is the main component of rocks or soils. Aluminum-containing ores include feldspar, mica, cryolite, bainite, potter's clay, and the like, and aluminum oxides include gems, such as rubies, sapphires, and corundum.

Aluminum is a silvery-white soft metal that is bulky and ductile and can be made into a foil or a wire. Its properties depend on its purity, and it is an electric conductor and has a resistivity equal to about 1.6 times that of copper. Aluminum is a typical light metal in terms of specific gravity. When aluminum is allowed to stand in air, it loses its gloss due to a thin oxide layer foiled thereon, but the inside thereof is not eroded. When aluminum is heated near the melting point thereof in air, it burns while emitting white light and becomes aluminum oxide. At this time, aluminum reaches a high temperature, so powder is used to metallize or weld the metal.

Silicon (Si) that is used as an additive in the present invention may be conventional silicon in powder form.

Silicon has an atomic number of 14 and is mainly used in research and industrial fields related to semiconductors. Silicon is produced mainly as single crystals.

Silicon oxide (SiO₂), i.e., a relatively simple silicon compound, has long been known as flint or quartz, and a material, such as silica sand, was used as a raw material for glass production in ancient Egypt. Silicon was first discovered as a simple substance by Swedish chemist J. Vercellius in 1822 and was obtained by reducing silicon fluoride with potassium metal. Silicon is not produced in a free state in nature, but exists as oxides and silicates, and is a major constituent of the lithosphere. Its Clarke number (abundance in the crust) is second (27.6%) after oxygen. Silicon is also contained in rice, bamboo, hibiscus, diatoms, animal feathers and claws, sponges, and the like.

Amorphous silicon is brown powder, and crystalline silicon is dark blue-black in color and has a needle-like or sheet-like octahedral structure. Silicon has a diamond-like structure and is a typical semiconductor together with germanium. It is stable in air at room temperature but reacts with fluorine, and it also reacts with chlorine, oxygen or nitrogen when heated. It also reacts with carbon at high temperatures to produce silicon carbide. It is slowly oxidized by aqua regiato produce silicon dioxide, and is readily soluble in a mixture of hydrofluoric acid and nitric acid and in an alkali hydroxide solution but not in other acids. It dissolves in a caustic alkali aqueous solution while generating hydrogen, thereby producing silicate. When silicon is reacted with metal sodium and halogenated alkyl, an organosilicon compound is produced. Since silicon is an excellent semiconductor, it is used in microwave ore detectors (transistors, diodes, etc.) and effectively works even at shorter wavelengths than using germanium.

In addition, silicon is a raw material for various silicon resins, and is used in large quantities as a reducing agent, a deoxidizer and an alloying element in metal material fields. Steel materials usually have an iron silicide content of about 70%, and high-silicon cast iron (about 15% silicon) is known as an acid-resistant alloy. silicon steel sheets having a silicon content of 0.5 to 4.2% has high magnetic inductance and is used as an iron core of a transformer or the like. Copper alloys have a silicon content of about 4.5% and are used for telegraphic and telephone lines. Aluminum alloys have a silicon content of about 13% and are used as silumin alloys.

Calcium (Ca) that is used as an additive in the present invention may be calcium that is generally used.

The surface of calcium is covered by an oxide layer in air. When calcium is allowed to stand for a long time, it absorbs moisture and slowly changes to hydroxide or carbonate. When calcium is strongly heated in air, it burns to produce calcium oxide and calcium nitride.

Calcium reacts with nitrogen and hydrogen at high temperatures to produce calcium nitrate and calcium hydride, respectively. Calcium reacts violently with fluorine at room temperature, and combines with chlorine, bromine, and iodine at high temperatures to produce calcium halides. At high temperatures, calcium combines with sulfur, selenium, phosphorus and arsenic, and also directly with carbon, silicon, and boron. Calcium is capable of reducing a large amount of oxides because the generation heat of the oxides is large, and is used as a deoxidizing agent in metal refining.

Calcium reacts gently with water at room temperature, because the calcium hydroxide generated acts as a protective layer.

When heated, calcium breaks water vigorously to generate hydrogen. Calcium reacts violently with hydrochloric acid, nitric acid and sulfuric acid to dissolve them, and does not react with ammonia at room temperature, but dissolves well in liquid ammonia. Calcium forms amalgam with mercury, and forms alloys with alkali metals and many other metals. Calcium reacts with carbon dioxide and carbon monoxide at high temperatures to produce calcium carbide, calcium oxide and carbon. Calcium reduces many organic substances and generates hydrogen in ethanol to generate calcium ethoxide, so that caution is needed when it is used for the dehydration of ethanol.

The present invention may provide a degradable resin pellet obtained by adding polyvinyl alcohol (PVA) to the above-described degradable resin pellet.

The present invention may provide a degradable resin pellet obtained by adding polyvinyl alcohol (PVA) to the above-described degradable resin pellet in an amount of 50 to 150 parts by weight based on 100 parts by weight of the polylactic acid (PLA).

In the present invention, the polyvinyl alcohol (PVA) is also referred to as PVA.

When polyvinyl acetate is hydrolyzed with sodium hydroxide in methyl alcohol solution at a temperature of 30 to 50° C., it is precipitated as a white solid. Polyvinyl acetate is a white powder that is soluble in water but insoluble in organic solvents. It is used as an additive in zinc plating. It is used as a raw material for polyvinyl alcohol synthetic fibers and is used in adhesives, thickeners, films, and the like.

The present invention may provide a degradable resin pellet obtained by adding polyethylene (PE) to the above-described resin pellet.

The present invention may provide a degradable resin pellet obtained by adding polyethylene (PE) to the above-described degradable resin pellet in an amount of 50 to 150 parts by weight based on 100 parts by weight of the polylactic acid (PLA).

The polyethylene (PE) that is used in the present invention is a chain-shaped polymer compound produced by polymerization of ethylene.

Various polyethylenes are produced by various polymerization methods, and are classified according to density into low-density polyethylene and high-density polyethylene. Low-density polyethylene is used as a raw material for various bottles and ice making boxes for refrigerators.

Polyethylenes contain several branched structures or double bonds depending on synthesis conditions, but mostly have a linear structure. Polyethylenes having molecular weights of about 6000 or greater are semi-transparent or transparent, combustible wax-like solids and have very good thermoplastic properties. Polyethylene is well resistant to water, acids, alkalis and solvents, but dissolves in high-temperature hydrocarbons and chlorine compounds. Polyethylene also has good electrical insulation, water resistance, moisture proof and cold resistance properties. Polyethylene is a synthetic resin having a relatively small specific gravity, a large mechanical strength, and good processability, so that it can be heat-sealed. However, polyethylene is flammable, has a large coefficient of theimal expansion, is not permeable to moisture, but is easily permeable to gas.

Although these properties are somewhat different depending on polyethylene production methods, the polyethylene produced by the low-pressure method or the medium-pressure method has better crystallinity compared to the polyethylene produced by the high-pressure method, and thus has excellent hardness, strength, heat resistance and cold resistance, but has slightly poor processability and weather resistance. When heated at a temperature above 300° C., polyethylene is thermally degraded or oxidized, but the production of ethylene is very insignificant. In addition, polyethylene is chlorinated or chlorosulfonated, in which the chlorinated polyethylene has excellent performance, and the chlorosulfonated polyethylene is used as synthetic rubber. Polyethylene is crosslinked by irradiation.

The present invention provides a degradable resin pellet configured as described above.

The present invention provides a degradable resin pellet obtained by adding resin additives, such as a thermal stabilizer, to the above-described degradable resin pellet.

The present invention provides a degradable resin pellet obtained by adding, to the above-described degradable resin pellet, based on 100 parts by weight of the polylactic acid (PLA), 5 to 10 parts by weight of a thermal stabilizer, 5 to 15 parts by weight of 2,5-dimethyl-1-2,5-di(tert-butylperoxide)hexane (C₁₆H₃₄O₄), 5 to 15 parts by weight of plant sugar (C₁₂H₂₂O₁₁), and 5 to 25 parts by weight of isopropyl titanium triisostearate (C₅₇H₁₁₂O₇Ti).

The thermal stabilizer that is used in the present invention may be a conventional thermal stabilizer that is used for molding of polymer materials.

The thermal stabilizer serves to maintain the quality of each component by minimizing the development of deformation during heating for pellet formation, and examples thereof include phosphoric acid, monomethylphosphoric acid, triphenylphosphoric acid, triphenylphosphoric acid, trimethylphosphoric acid, tributylphosphoric acid, triocrylphosphoric acid, monophenylphosphoric acid, triphenylphosphoric acid and their derivatives, or phosphorous (P)-based stabilizers, phosphorous acid, triphenylphosphorous acid, trimethylphosphorous acid and their derivatives.

The plant sugar functions as an oxidation accelerator, accelerates the oxidation/reduction reaction of thermoplastic polymers, and attacks the carbon-carbon bonds of thermoplastic polymers when the autoxidation thereof is initiated, thereby producing peroxides and carboxyl compounds. In addition, the sugar itself can be used as a nutrient source for microorganisms, and thus the oxidative biodegradation of thermoplastic polymers containing the same can be promoted.

In addition, the plant sugar that is used in the present invention is obtained from natural materials, such as corn, fruits, sugar cane and the like, and may be a natural component, such as maltitol, dextran, trehalose or the like.

If the plant sugar is added in an amount of less than 5 parts by weight, the degradability of the pellet will be insufficient, and, if the plant sugar is added in an amount of more than 15 parts by weight, it will affect the contents of other components to reduce the physical properties and processability of the pellet.

A technical feature of the present invention is to provide a degradable resin pellet obtained by further adding ethyl acetate and methyl methacrylate to the above-described degradable resin pellet.

The ethyl acetate and methyl methacrylate that are further added to the degradable resin pellet function to increase surface smoothness and the adhesion between the molecules of polymer materials and to prevent cracks and bubbles from occurring during extrusion molding of the resin pellet.

In the present invention, it is very preferable to add, based on 100 parts by weight of the polylactic acid (PLA), 0.1 to 1 part by weight of ethyl acetate and 0.2 to 2 parts by weight of methyl methacrylate.

A technical feature of the present invention is to provide a degradable resin pellet obtained by adding dry starch and a polyolefin grafted with carboxylic acid or an anhydride thereto to the above-described degradable resin pellet.

The present invention provides a degradable resin pellet further including, based on 100 parts by weight of the polylactic acid (PLA), 10 to 60 parts by weight of dry starch and 0.3 to 4 parts by weight of a polyolefin grafted with carboxylic acid or an anhydride thereof.

Although the starch that is used in the present invention has the disadvantage of being carbonized at high temperatures, it functions to enable extrusion at lower temperatures by its reaction with the resin additives. The starch also functions to significantly increase the strength and hardness of a molded article obtained using the degradable resin pellet.

In particular, the polyolefin grafted with carboxylic acid or an anhydride thereof, which is used in the present invention, functions to increase the strength of a molded article during molding using the degradable resin pellet, and also functions to prevent cracks from occurring during injection and cooling of the molded article.

A technical feature of the present invention is to provide a degradable resin pellet obtained by further adding a cellulose, amide and a nutrient, selected from blue-green algae and/or yeast, to the above-described resin pellet.

The present invention provides a degradable resin pellet further including, based on 100 parts by weight of the polylactic acid (PLA), 0.5 to 5 parts by weight of cellulose, 0.3 to 3 parts by weight of amide, and 0.5 to 5 parts by weight of blue-green algae and/or yeast.

The cellulose that is used in the present invention functions to enable the persistent polymer chains of biodegradable resin, which contain a number of weak C—C bonds, C—H bonds and H—H bonds, to be fixed together by the hydrogen bonds between a number of adjacent OH groups present in the cellulose, thereby creating weak polymer chains containing monomer units, making the pellet susceptible to biodegradation.

The cellulose that is used in the present invention may be selected from among plant celluloses, cotton seed extracts or plant fibers.

The amide that is used in the present invention functions to enhance intermolecular bonds during formation of the degradable resin pellet, thereby enhancing the durability of a molded article formed from the degradable resin pellet.

The amide that is used in the present invention may be selected from among nitrates, such as ammonium nitrate, potassium nitrate, calcium nitrate or sodium nitrate, and combinations of nitrides and nitrates.

The blue-green algae and/or yeast that are used in the present invention function to promote the biodegradation of a molded article formed from the biodegradable resin pellet of the present invention, thereby solving environmental problems.

When the blue-green algae and yeast are used, they are preferably added in an amount of 0.5 to 5 parts by weight based on 100 parts by weight of the polylactic acid (PLA) as described above.

The blue-green algae that is used in the present invention may be selected from among deep blue algae, agar media, green algae nutrient media, agar extracts, agar gels, and agar proteins.

The yeast that is used in the present invention may be selected from among microbiological nutrient media, agar yeast media, yeast extracts, powdered dry and wet yeasts, liquid yeasts, yeast syrups, invertase, and the like.

A technical feature of the present invention is that the degradable resin pellet further includes one or more compounds selected from the group consisting of polyalkylene oxide, aliphatic polyester, polyhydric alcohol ester, and polyhydric carboxylic acid ester, wherein the compounds have a boiling point of 250° C. or higher and a number-average molecular weight of 200 to 50,000.

According to the present invention, one or more compounds selected from the group consisting of polyalkylene oxide, aliphatic polyester, polyhydric alcohol ester, and polyhydric carboxylic acid ester are added to the above-described degradable resin pellet in an amount of 0.2 to 1 part by weight based on 100 parts by weight of the polylactic acid (PLA).

The one or more compounds selected from among polyalkylene oxide, aliphatic polyester, polyhydric alcohol ester and polyhydric carboxylic acid ester, added as described above, function to prevent a molded article from being deformed during the production of the molded article from the degradable resin pellet.

A technical feature of the present invention is that the degradable resin pellet further includes natural zeolite powder, mordenite ore powder, and Gunma feldspar powder.

The degradable resin pellet according to the present invention is characterized by further including, based on 100 parts by weight of the polylactic acid (PLA), 1 to 3 parts by weight of natural zeolite powder, 1 to 2 parts by weight of mordenite ore powder, and 1 to 2 parts by weight of Gunma feldspar powder.

The natural zeolite that is used in the present invention has a Mohs hardness of 6 or less and a specific gravity of about 2.2. The zeolite has a crystal structure in which the bonding of each atom is loosened and the skeleton remains intact even when the moisture filling the space is discharged with high heat, so that the zeolite can adsorb other particulate materials and can separate particulate materials having different sizes. In addition, the zeolite has an anion exchange property, and thus is mainly used as an adsorbent, a molecular sieve for separating particular materials having different sizes. In addition, the zeolite is used as a water softener based on a cation exchange property.

The mordenite ore powder that is used in the present invention has an orthorhombic crystal, has a Mohs hardness of 4 to 5, has a prismatic crystal, and is fine needle-like or fine fiber-like, and thus it is used as a deodorant, a disintegrant, heat loss material, catalyst ball or the like.

Unlike common ceramics that emit 90% or more of far-infrared rays at a high temperature of 40° C., the Gunma feldspar powder that is used in the present invention emits 96% of far infrared rays at 25° C. (i.e., room temperature), and generates up to 24,000 anions/cc, which is about 10-fold higher than that of tourmaline. The Gunma feldspar powder has a high surfactant effect and is a natural material beneficial to the human body, which contains no radioactive element. It is used as a far-infrared ray pack, powder toothpaste, catalyst ball or the like.

The degradable resin pellet including the natural zeolite powder, mordenite ore powder and Gunma feldspar powder, even when famed into a molded article, has functions, such as antibacterial, disinfectant and deodorant functions, and thus the molded article has an increased usage function and performs the function of being prevented from oxidation, thereby exhibiting enhanced durability.

In addition, according to the present invention, a molded article, such as a conventional regulation garbage bag or a plastic bag, is produced from the above-described degradable resin pellet by a conventional method.

FIGURE is a diagram showing a conventional process of producing a molded article, such as a bag, from the above-described degradable pellet according to one embodiment.

Therefore, the present invention provides a molded article produced using the degradable resin pellet.

### INDUSTRIAL APPLICABILITY

The present invention is very useful in industries that produce and distribute biodegradable resin pellets.

Furthermore, the present invention is very useful in industries that produce molded articles using biodegradable resin pellets and distribute the molded articles.

1. A degradable resin pellet comprising a composition comprising 100 parts by weight of polylactic acid (PLA), 50 to 150 parts by weight of calcium carbonate (CaCO₃), 0.1 to 10 parts by weight of magnesium, 0.1 to 10 parts by weight of aluminum, 0.1 to 10 parts by weight of silicon, and 0.5 to 20 parts by weight of calcium;
wherein the composition is mixed with, based on 100 parts by weight of the polylactic acid (PLA), 50 to 150 parts by weight of polyvinyl alcohol (PVA); and
wherein the composition is further mixed with, based on 100 parts by weight of the polylactic acid (PLA), 50 to 150 parts by weight of polyethylene (PE).

2. The degradable resin pellet of claim 1,
further comprising, based on 100 parts by weight of the polylactic acid (PLA), 10 to 60 parts by weight of dry starch and 0.3 to 4 parts by weight of a polyolefin grafted with carboxylic acid or an anhydride thereof; and
further comprising, based on 100 parts by weight of the polylactic acid (PLA), 0.5 to 5 parts by weight of cellulose, 0.3 to 3 parts by weight of amide, and 0.5 to 5 parts by weight of blue-green algae or yeast.

3. A molded article produced using the degradable resin pellet of claim 1.

4. A molded article produced using the degradable resin pellet of claim 2.
